(19) United States
(12) Patent Application Publication
(10) Pub. No.: US 2022/0065781 A1
(43) Pub. Date: Mar. 3, 2022

(54) Method to Estimate Surface Gloss

(71) Applicant: DATACOLOR INC., Lawrenceville, NJ (US)

(72) Inventors: Zhiling Xu, Princeton Junction, NJ (US); Bill Binder, Stockton, NJ (US); Venkata R. Thumu, Pennington, NJ (US)

(21) Appl. No.: 17/008,356

(22) Filed: Aug. 31, 2020

(51) Int. Cl. G01N 21/57

(52) U.S. Cl. CPC G01N 21/57; G06F 7/552; G01N 2201/12746

(57) ABSTRACT

As described herein, a method has been developed to estimate the gloss of a black or dark sample using a color measurement system. In such a system, when measuring a higher gloss sample, more illumination light reflected from the sample surface will be directed away from the receiving sensor, and thus less signal will be detected. Using a derived sensor-signal to surface-gloss relationship, the surface gloss of a sample can be calculated by applying the measurements of the sample to the signal to gloss relationship to obtain a more accurate gloss measurement of a sample under analysis.

### FIELD OF THE INVENTION

The present invention is directed to measurement devices and approaches for improving full spectrum information recovery of samples with different gloss characteristics.

### BACKGROUND OF THE INVENTION

Gloss is an important property of an object. Typically, in order to get the gloss value of a surface, a dedicated gloss meter is needed, and various methods have been developed to improve the measurement accuracy, such as a method disclosed in US patent “System and Apparatus for Gloss Correction in Color Measurements” (U.S. Pat. No. 8,680,99362) granted to Z. Xu, et. al., herein incorporated by reference as if presented in its entirety.

Color is also a very important property of an object. Dedicated instruments such as colorimeters or spectrophotometers have been developed to measure color values of a sample, and various methods have been used to improve the measurement performance. For example, in US patent “Spectrum Recovery in a Sample” (U.S. Ser. No. 10/444,07461) granted to Z. Xu, et. al., herein incorporated by reference in its entirety, multiple light sources can be used to get better spectrum information in an abridged spectrophotometer.

However, color measurement is often sensitive to the surface gloss of a sample, as described in Datacolor white paper “Understanding Datacolor Gloss Compensation” (https://knowledgebase.datacolor.com/admin/attachments/gloss_compensation_dci.pd f), herein incorporated by reference as if presented in its entirety. Therefore, in order to get the gloss information, a gloss meter needs to be used separately or integrated into the color measurement device. Such integrations typically add cost and complexity to the measurement devices. Thus, what is needed in the art is an approach that allows for the estimation of the gloss of a sample in a color measuring device without the added complexity of adding a gloss meter to an existing machine.

### SUMMARY OF THE INVENTION

As described herein, a method has been developed to estimate the gloss of a black or dark sample using a color measurement system. In such a system, when measuring a higher gloss sample, more illumination light reflected from the sample surface will be directed away from the receiving sensor, and thus less signal will be detected. Using a derived sensor-signal to surface-gloss relationship, the surface gloss of a sample can be calculated by applying the measurements of the sample to the signal to gloss relationship.

In one particular implementation, a method of determining the gloss properties of a sample is described. Here, the method includes the steps of measuring, using a light measurement device, light emitted by an illuminant and reflected off of the sample to obtain one or more measurement values and accessing, using one or more processors configured to execute code, a gloss model, wherein the gloss model is configured to accept the one or more measurement values as input values to the gloss model and output a corresponding gloss value. The method also includes applying, using one or more processors configured to execute code, the one or more raw measurement value as an input to the gloss model and receiving, using one or more processors configured to execute code therein, a gloss value that corresponds to at least the one or more measurement value. This gloss value can then be output to one or more devices for use or display.

In a further implementation, a method of generating a measurement to gloss model is provided. The method for generating the measurement to gloss model includes the steps of measuring, using a light measurement device, light emitted by an illuminant and reflected off of one of a plurality of samples to obtain a first measurement value. Here, the one of the plurality of samples is formed of a first material. The first measurement value is associated with a corresponding gloss value for the first material. In a particular implementation, generating a measurement to gloss model further includes measuring, using the light measurement device, light emitted by the illuminant and reflected off of at least one other sample of a plurality of samples to obtain a second measurement value. Here, the at least one other of the plurality of samples is formed of a second material different from the first material. The second measurement value is associated with a corresponding gloss value for the second material. The model generation process also includes generating, using at least the first measurement value and gloss value and the second measurement value and gloss value, a gloss model that correlates, using the relationship between each measurement value and gloss value an input of a new measurement value to a corresponding output gloss value.

### BRIEF DESCRIPTION OF THE DRAWINGS

FIG. 1 is a schematic illustration detailing particular elements of the described gloss estimation apparatus.

FIG. 2 is a flow diagram detailing particular steps in a gloss estimation process.

FIG. 3 is a block diagram detailing particular elements of the gloss estimation apparatus.

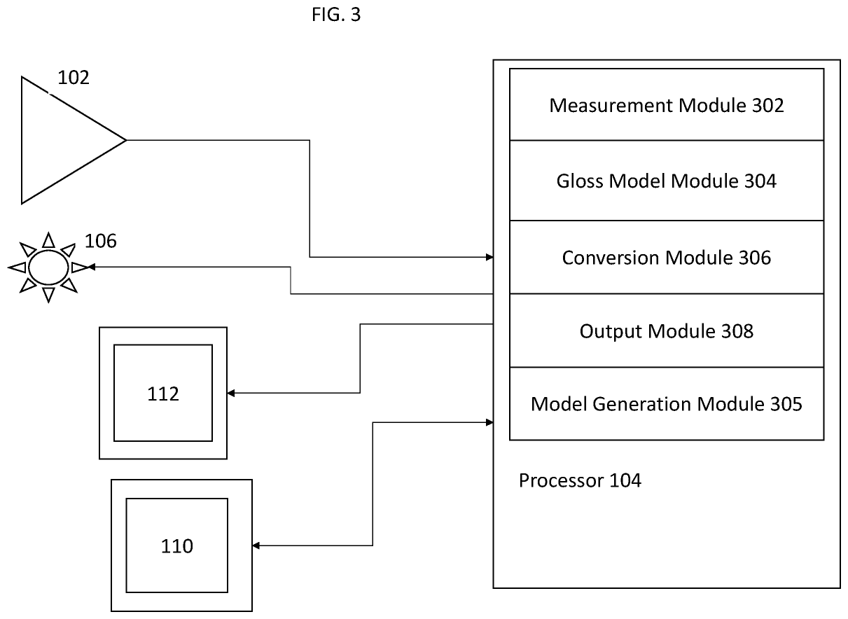

FIG. 4 is a chart detailing the relationship between independent and dependent variables in a gloss model.

FIG. 5 is a flow diagram detailing particular steps in the gloss estimation process.

### DETAILED DESCRIPTION OF CERTAIN EMBODIMENTS OF THE INVENTION

By way of overview and introduction, a method is provided to estimate the gloss of a black or dark sample in a gloss sensitive color measurement system by obtaining a sensor-signal to surface gloss relationship and using such a relationship to estimate the gloss of a sample having unknown gloss properties.

It will be appreciated that color can be measured with various instruments such as colorimeters and spectrophotometers. Depending on the geometry of the measurement instrument, the surface gloss of a sample may impact the color measurement results. For example, a specular component included (SCI) instrument is less sensitive to the surface gloss of a sample. Alternatively, an instrument having a bi-directional configuration, such as a 45/0 instrument, is sensitive to the surface gloss of a sample.

Sometimes a color measuring instrument is needed (such as an SCI integrating sphere) that is not sensitive to the surface gloss of a sample, but one has instead an instrument (such as a 45/0 instrument) that is quite sensitive to the gloss. The foregoing disclosure describes estimating the surface gloss of a sample using a 45/0 geometry and using the estimated gloss to match SCI. Many color measuring instruments, even instruments like the 45/0 that are sensitive to gloss, lack an integrated gloss meter. As a result, it is difficult using currently available devices to obtain the gloss information of the sample under measurement.

As described in more detail herein, a method has been invented to estimate the surface gloss of a sample using the relationship between the different samples of the same color but with different surface gloss. In a particular implementation, the described method is used to determine the gloss value of a black or dark colored sample. It has been found that the further the color of a sample deviates from black, the higher noise will be added. Higher noise, it should be understood, has a negative effect on the accuracy of result of the measurement process. The result will be less accurate. Therefore, for a sample that is not dark, a black sample with similar surface gloss can be measured. Using this measurement, an estimate of the gloss properties of the non-black sample are obtained. Using the relationship between the color measurement of a black sample and its gloss value is an efficient mechanism to estimate the gloss value of a sample. For example, manufacturing or production processes typically involve working with similar materials having different color pigments added. Therefore, the surface gloss of various color samples of the same material are likely to be similar because of the inherent properties of the materials. Where there is a black sample of a material used in a production process, such material can be evaluated for its gloss measurement value. Using the gloss value for the black colored version of the material under analysis as an input, a suitably configured processor can calculate the estimated gloss value for other color samples of the same material.

In the foregoing example, color measurement devices are used to measure the gloss of a black sample. Here, the color measurement device has a 45/0 geometry. However, other measurement or pick-up geometries are also contemplated.

When a 45/0 device is used to measure a sample, the signal received by the detector includes some light from under the sample surface and some light from the sample surface. The under-surface reflection is generally diffuse and will contribute to the 0-deg sensor input no matter what the angle of the incident light. The sample-surface-reflected light may be reflected in a single direction if the surface is high-gloss, or in a variety of directions if the surface is low-gloss. In calibrating gloss, it is important to minimize the reflection of the under-surface so as to assess the surface. This is done using a gloss ladder, which comprises a set of samples whose under-surface color is black but which have different gloss values for the sample surface.

For a high-gloss sample in the gloss ladder, the 0-deg light measurement contains little contribution from the specular component. However, lower-gloss samples (which are similarly black in their under-surface color) will have more sample-surface (specular) light scattered into the 0-deg sensor than higher-gloss samples do.

By obtaining the sensor measurement values for multiple samples of different surface glosses but of the same under-surface color, a signal-to-gloss relationship for a given color measurement device is generated. After that, the light measurement device is used to measure a sample. Using this light measurement result and the previously generated signal-to-gloss relationship, the gloss value for the sample can be determined.

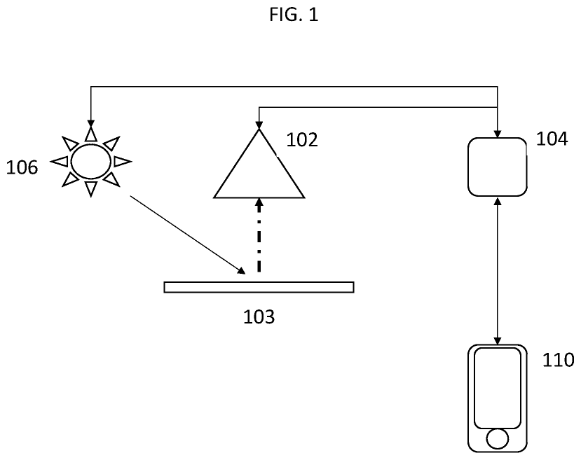

Turning now to FIG. 1, a light measurement device 102 is used to measure a sample 103. In a particular implementation, the sample 103 is illuminated by a light source 106. In one or more implementations, the light source 106 is an LED, OLED, LCD or other light emitting device. In further implementations, the light source 106 is a halogen, incandescent, mercury or other light source that is configured to illuminate the sample in visible light. In an implementation where the light source 106 is a broad band LED configured to provide uniform, or near uniform, light intensity across the visible light spectrum. In another arrangement, the light source 106 is formed of a collection of separately addressable lighting elements. For example, in one or more implementations, the separately addressable lighting elements are narrow band illuminations such that each lighting element is configured to produce a narrow band of illumination about a given wavelength or wavelength range. In one or more further implementations, each of the light sources are configured to be activated in response to one or more control signals or flags from a lighting controller.

In a particular implementation, the light source or light sources are movable or adjustable to provide different illumination geometries based on user need. For example, one or more lighting elements are positioned to provide a 45/0 illumination geometry. In other arrangements, the lighting elements are positioned to other illumination geometries. In one or more particular implementations, multiple lighting elements are provided such that the desired geometry can be selected and used in connection with the spectrum recovery process described herein.

Upon activation of one or more light sources 106, the light (as shown in dashed lines) illuminates a sample 103. In one or more implementations, the sample 103 is a color swatch, fan deck, color sample, product, item or object. For example, the sample 103 is an object having high gloss properties. In another arrangement, the sample 103 is an object having low gloss properties. In another implementation, the sample 103 is any object where the color values and/or the gloss properties of the object is unknown or in need of clarification. Light that has been reflected off the sample 103 (shown in dotted lines) is then received by one or more light sensing elements of a light sensor of the light measurement device 102. For example, the light that has been reflected off the sample 103 strikes one or more photoelectric cells and causes a signal to be produced corresponding to the wavelength, intensity or other property of the light received.

In one implementation the light measurement device 102 is a spectrophotometer, colorimeter or other color measurement device. In a further implementation, the light measurement device 102 is a collection or array of photometers, light sensing elements, or other similar devices. In a further implementation, the color measurement device is one or more cameras or image acquisition devices such as CMOS (Complementary Metal Oxide Semiconductor), CCD (charged coupled device) or other color measurement devices. Such sensors can include data acquisition devices and associated hardware, firmware and software that is used to generate color values for a given sample. In one or more implementations, both a primary light sensor and a reference channel sensor are used to capture light measurements. In a further particular implementation, the light measurement device 102 is used to generate spectrum color values of the sample 103.

In a further arrangement, multiple sensors can be oriented within a housing or support structure that includes at least the light source 106 and the light measurement device 102. In this configuration, different sensors and light sources are oriented so as to provide different measurement geometries known to those possessing an ordinary level of skill in the requisite art.

In yet a further implementation, the light measurement device 102 is configured to have a plurality of channels for measuring different wavelengths of light. In one implementation the light measurement device 102 is configured to measure light across the visible wavelength spectrum. For example, the light measurement device 102 uses 16 measurement channels. In another implementation, the light measurement device 102 has 31 measurement channels to measure the light that interacts with the light measurement device. Here, each of the different measurement channels measures a different wavelength range. In other implementations, the light measurement device 102 has less than 16 channels. For instance, the light measurement device has 8 or 6 measurement channels for measuring the visible wavelength spectrum.

The light measurement device 102, in accordance with one embodiment, is a stand-alone device that is configured to one or more components, interfaces or connections to one more processors, networks, or storage devices. In such an arrangement, the light measurement device 102 is configured to communicate with associated processors, networks, and storage devices using one or more USB, FIREWIRE, Wi-Fi, GSM, Ethernet, Bluetooth, and other wired or wireless communication technologies suitable for the transmission color, image, spectral, or other relevant data and or metadata. In an alternative arrangement, the light measurement device 102 is a component of a smartphone, tablet, cell phone, workstation, testing bench, or other computing apparatus.

The measurements obtained by the light measurement device 102 are passed directly or indirectly to a computer or processor 104 for evaluation and/or further processing. The processor 104 is configured by one or more modules stored in memory 105 to derive spectrum measurements using stored data, raw counts, coefficients or other values. In an alternative configuration, the processor 104 is able to access from the database 108 one or more coefficients for application to the measurements obtained by the light measurement device 102 in order to provide updated or corrected color measurements to a database 108 or a user interface device 106. In one implementation the coefficients used to convert the measured color values to the output color values are stored as a dataset in the database 108.

With further reference to FIG. 1, the processor 104 is a computing device, such as a commercially available microprocessor, processing cluster, integrated circuit, computer on chip or other data processing device. In one or more configurations, the processor is one or more components of a cellphone, smartphone, notebook or desktop computer configured to directly, or through a communication linkage, receive color measurement data captured by the light measurement device 102. The processor 104 is configured with code executing therein to access various peripheral devices and network interfaces. For instance, the processor 104 is configured to communicate over the Internet with one or more remote servers, computers, peripherals or other hardware using standard or custom communication protocols and settings (e.g., TCP/IP, etc.). The processor 104 comprises one or more of a collection of micro-computing elements, computer-on-chip, home entertainment consoles, media players, set-top boxes, prototyping devices or “hobby” computing elements. The processor 104 can comprise a single processor, multiple discrete processors, a multi-core processor, or other type of processor(s) known to those of skill in the art, depending on the particular embodiment.

In one configuration, the processor 104 is a portable computing device such as an Apple iPad/iPhone® or Android® device or other commercially available mobile electronic device executing a commercially available or custom operating system, e.g., MICROSOFT WINDOWS, APPLE OSX, UNIX or Linux based operating system implementations. In other embodiments, the processor 104 is, or includes, custom or non-standard hardware, firmware or software configurations.

In one or more embodiments, the processor 104 is directly or indirectly connected to one or more memory storage devices (memories) to form a microcontroller structure. The memory is a persistent or non-persistent storage device (such as memory 105) that is operative to store the operating system in addition to one or more of software modules 107. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as through the use of removable media cards or modules. In one or more embodiments, the memory of the processor 104 provides for the storage of application program and data files. One or more memories provide program code that the processor 104 reads and executes upon receipt of a start, or initiation signal. The computer memories may also comprise secondary computer memory, such as magnetic or optical disk drives or flash memory, that provide long term storage of data in a manner similar to the persistent memory device 105. In one or more embodiments, the memory 105 of the processor 104 provides for storage of application programs or modules and data files when needed.

As shown, memory 105 and persistent storage 108 are examples of computer-readable tangible storage devices. A storage device is any piece of hardware that is capable of storing information, such as, data, program code in functional form, and/or other suitable information on a temporary basis and/or permanent basis. In one or more embodiments, memory 105 includes random access memory (RAM). RAM may be used to store data in accordance with the present invention. In general, memory can include any suitable volatile or non-volatile computer-readable storage device. Software and data are stored in persistent storage 108 for access and/or execution by processors 104 via one or more memories of memory 105.

In a particular embodiment, persistent storage 108 includes a magnetic hard disk drive. Alternatively, or in addition to a magnetic hard disk drive, persistent storage 108 can include a solid state hard drive, a semiconductor storage device, read-only memory (ROM), erasable programmable read-only memory (EPROM), flash memory, or any other computer-readable storage devices capable of storing program instructions or digital information.

The database 108 may be embodied as solid-state memory (e.g., ROM), hard disk drive systems, RAID, disk arrays, storage area networks (“SAN”), network attached storage (“NAS”) and/or any other suitable system for storing computer data. In addition, the database 108 may comprise caches, including database caches and/or web caches. Programmatically, the database 108 may comprise flat-file data store, a relational database, an object-oriented database, a hybrid relational-object database, a key-value data store such as HADOOP or MONGODB, in addition to other systems for the structure and retrieval of data that are well known to those of skill in the art.

The media used by persistent storage 108 may also be removable. For example, a removable hard drive may be used for persistent storage 108. Other examples include optical and magnetic disks, thumb drives, and smart cards that are inserted into a drive for transfer onto another computer-readable storage medium that is also part of persistent storage 108.

In one or more implementations, the processor 104 includes one or more communications or network interface units. These units provide for the ability to transfer data obtained from the light measurement device 102 to one or more remote devices 106. In one or more implementations, the communications unit may provide appropriate interfaces to the Internet or other suitable data communications network to connect to one or more servers, resources, API hosts, or computers. In these examples, communications unit may include one or more network interface cards allowing for Bluetooth, ZigBee, serial, ethernet, or other wired or wireless communication protocols. In one or more implementations, the communication unit allows for data processed by the processor 104 to exchange data in real-time or near real-time with a user interface device 106 or databases 108.

In one implementation, the display device 112 is a screen, monitor, display, LED, LCD or OLED panel, augmented or virtual reality interface or an electronic ink-based display device that is integrated to the spectrum measurement device described herein. In one or more implementations, the display device 112, the processor 104, the lighting source 106 and the light measurement device 102 are incorporated into a single housing. For example, a portable light measurement device can incorporate elements 102-106 into a single form factor.

In an alternative implementation, the data can be exchanged with the light measurement device 102 and the associated processor 104 using a remote computing device 110. Here the remote computing device 110 is a remote computer that can receive, and display data sent by the processor 104. For example, measurements and data processed by the processor 104 is transmitted to the remote computing device 110 and displayed on a display device that is associated with the remote computing device 110. By way of non-limiting implementation, the remote computing device 110 is a portable computer (such as a mobile telephone, portable computer and other devices) that is configured to receive data from the processor and display that data on a screen incorporated into such a remote computing device 110.

Those possessing an ordinary level of skill in the requisite art will appreciate that additional features, such as power supplies, power sources, power management circuitry, control interfaces, relays, interfaces, and/or other elements used to supply power and interconnect electronic components and control activations are appreciated and understood to be incorporated.

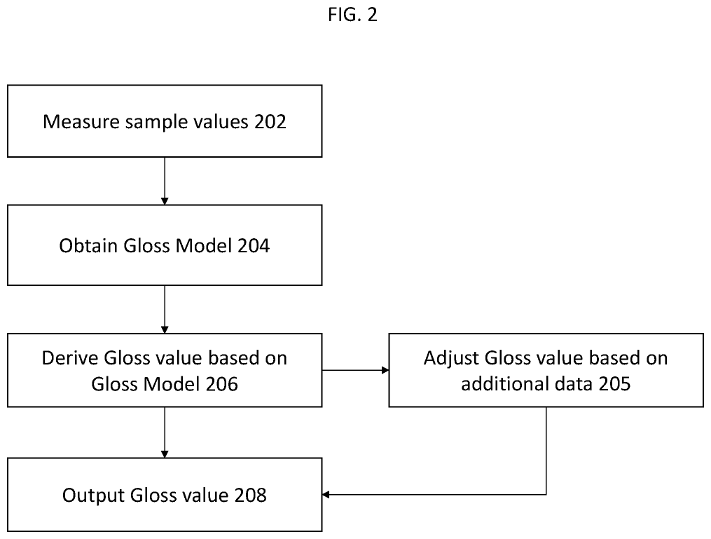

Turning now to the flow diagram of FIG. 2, the light measurement device 102 is configured to evaluate the gloss properties of a sample having unknown gloss properties. For example, as shown in measurement step 202, the sample 103 is illuminated by the light source 106 causing light to reflect off of the sample 103 and strike the light sensing elements of the light measurement device 102. In one particular arrangement, measurement step 202 is implemented by a processor 104 configured by a measurement module 302 and operative to send a signal to the light source 106 to illuminate the sample 103.

In one particular implementation, the measurement module 302 includes one or more submodules that configure the processor 104 to receive a user input signal to initiate the measurement process. For example, the measurement module 302 is configured to receive data from a user of a remote computing device 110 to initiate the measurement process. Here, remote computing device 110 can be a smartphone or mobile computer configured with software or an application that permits bi-directional communication with the light measurement device 102. In this configuration, the measurement module 302 configures the processor 104 to receive an initiation or start signal to begin the measurement step 202.

Continuing with step 202, the measurement module 302 includes one or more submodules that configure the processor 104 to obtain the data values generated by the one or more sensors of the light measurement device 102 when light that has been reflected off of the sample 103 reaches the sensor element of the light measurement device 102. In one particular implementation, the light measurement device 102 is configured to output a digital or analog signal to the processor 104 that corresponds to the amount of light received by the light measurement device 102. The measurement module 302, or a submodule thereof, configures the processor 104 to evaluate the data values generated by the light measurement device 102 and process them for further use. For instance, the measurement module 302 includes one or more submodules that configure the processor 104 to convert the digital or analog signals generated by the light measurement device 102 into values for further processing according to the disclosure provided herein.

Turning now to model access step 204, the processor 104 is configured to access a gloss conversion model to transform the measurement data obtained in measurement step 202. In one particular implementation, the processor 104 is configured by a gloss model module 304 to carry out model access step 204. For instance, the gloss model module 304 is code executing in the processor 104 that is operative to access from one or more persistent data storage 108, one or more gloss conversion models. In one implementation, the gloss conversion model is stored as code or data in one or more local data storage devices that are integrated into the light measurement device 102. In an alternative configuration, a gloss conversion model is accessed from a remote data storage device. For example, where a remote computing device 110 is configured to exchange data with the light measurement device 102, the gloss conversion model is stored within a memory local to the remote computing device 110.

Processor 104 is configured by one or more submodules of the gloss model module 304 to access and retrieve a given gloss conversion model. For example, where a user input received by the processor 104 contains information about a desired or preferred gloss conversion model, such as a particular gloss conversion model for a specific type of material, the gloss model module 304 causes processor 104 to access the desired gloss conversion model from the relevant persistent storage 108.

In one or more configurations, the gloss model module 304 configures the processor 104 to receive input from a user indicating the type of material under analysis. For example, a user operating a remote computing device 110 that engages in bidirectional communications with the processor 104, further configures the processor 104 to select among one or more preset gloss models for a given circumstance. For example, the processor 104 is configured to select a particular gloss model based a particular gloss relationship function that is suitable for the type of material under analysis. For example, where there are gloss models for fabrics and for ceramics accessible by the processor 104, the user input causes the processor 104 to select the appropriate gloss model for a ceramic sample. In another particular implementation, the processor 104 is configured to automatically determine the material or type of the sample based on one or more calibration routines.

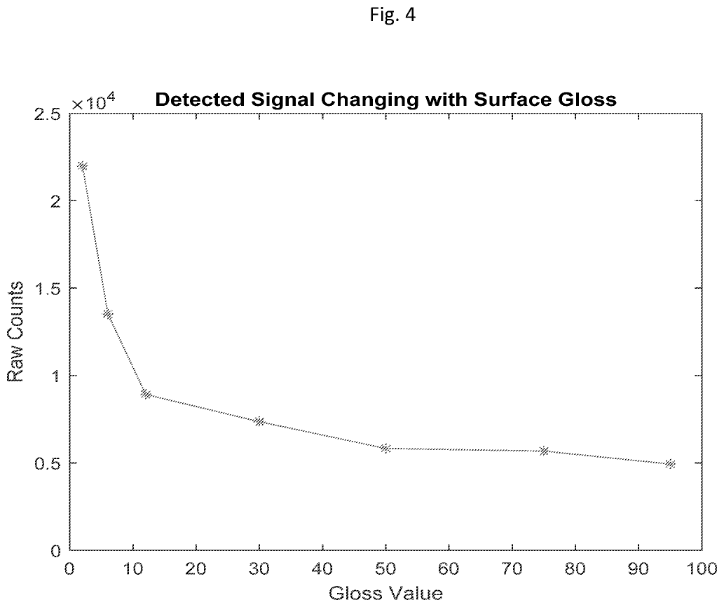

By way of further explanation, the chart shown in FIG. 4 provides the relationship between the raw measurement counts, using a color measurement device, for a collection of different sample materials each having the same color. In the particular example provided in FIG. 4, the gloss model provided is based on the known raw measurement count and gloss values for a collection of black colored samples of different materials. More specifically, the sensor used in the light measurement device 102 to obtain the chart of FIG. 4 is a 16-channel sensor and the total raw counts of the sensor is the summation of the raw counts of the 16 individual channels. As noted, the same colored samples of the different materials will produce different raw counts when measured with a light measurement device, such as light measurement device 102. Using this relationship, a function or model representing the gloss value of a sample as a function of the raw counts can be determined.

Using the gloss conversion model, the raw measurement data obtained from the sensors of the light measurement device 102 are converted into a gloss measurement of the sample 103, as in conversion step 206. In one or more implementations, the conversion step 206 is implemented by a processor 104 that is configured by a conversion module 306. Here, the conversion module 306 is code that is executing in the processor 104 and is operative to apply the raw measurement data from the light measurement device 102 as an input to the gloss model. For example, where the gloss model is a function or algorithm that receives input in the form of measurement raw count data, the conversion module 306 configures the processor 104 to apply the raw measurement data obtained in measurement step 202 to the gloss model. In turn, the conversion module 306, or a submodule thereof, configures the processor 104 to obtain the gloss measurement using the gloss model. For example, where the raw measurement count data is provided to the gloss model by the conversion module 306, the conversion module 306 further configures the processor 104 to output the corresponding gloss values according to the relationship established by the gloss model.

In a further implementation, the gloss value obtained by the conversion module 306 is further processed by the processor 104 as in step 205. In one or more implementations, the gloss value derived from steps 202-206 for sample 103 reflects the gloss value of the black color of the material of the sample 103. However, where the sample 103 is of a color different than black, additional processing step 205 allows for the further refinement of the gloss value for the sample 103. In one or more implementations of step 205, the conversion module 306, or one or more submodules thereof, configures the processor 104 to further transform the gloss value obtained in conversion step 206. For example, the conversion module 306 configures the processor 104 to access one or more gloss transformation models. Here, when the gloss value obtained in conversion step 206 is provided to the transformation model, the gloss value is corrected or adjusted. By way of non-limiting example, the transformation model adjusts the gloss value to take into account the difference in color between the color used to generate the gloss model and the color of the sample 103. For example, using the gloss value derived in conversion step 206, the processor 104 is configured to generate a new gloss value that accounts for the color of the sample 103. In one or more implementations, the transformation of the gloss color is accomplished by providing the gloss value to a transformation matrix for a given color. Using this transformation matrix, the gloss value for the sample 103 is adjusted so as to take into account the color of the sample 103.

In one or more implementations, the transformation matrix is accessed, in step 205, using the gloss model module 304. For instance, the processor 104 is configured by the gloss model module 304 to access or load an existing transformation matrix with proper gloss compensation values pre-stored in one of multiple profiles. However, in one or more alternative implementations, gloss model module 304 configures the processor 104 to create a transformation matrix with proper gloss compensation values or parameters based on prior measurement data or information. For example, a user is able to provide data or information regarding the expected measurement gloss value for a material, such as a calibration standard. Using the difference between the gloss value obtained in conversion step 206 and the known gloss value for the calibration standard, the processor 104 is able to generate or derive a suitable transformation matrix to obtain a more accurate reflectance spectrum for the sample where the sample is not black. Using a derived or accessed transformation matrix, a more accurate reflectance spectrum of the sample 103 is obtained in step 205.

As shown in output step 208, the processor 104 is further configured to obtain the output generated by the gloss measurement function in the conversion step 206. In one implementation, the processor 104 is configured by an output module 308 configured as code and operative to configure the processor 104 to carry out the steps of obtaining the gloss value from the conversion module 306. Furthermore, the output module 308 configures the processor 104 to provide the gloss value to one or more of a remote computing device 110, display device 112, or persistent storage 108.

For example, the output module 308 configures the processor 104 to send the gloss value to a remote computing device 110 that is in communication with the light measurement device 102. Here, the remote computing device 110 is configured by one or more remote display or processing applications operative within a processor of the remote computing device 110 to display the gloss value obtained in conversion step 206 or additional processing step 205. For example, where the remote computing device 110 is a smartphone or mobile computing device, the light measurement device 102 is configured to exchange data regarding the measurement of a sample 103. Here the remote computing device 110 displays the gloss values and other measurement information that may be available on the screen or display device of the remote computing device 110.

In an alternative arrangement, the output module 308 configures the processor 104 to transmit the gloss measurement obtained in conversion step 206, or additional processing step 205 to one or more display devices (such as display device 112) that are integrated or associated with the light measurement device 102. For instance, where the light measurement device 102 is configured with a display device 112 (such as a LED or LCD screen) that is integral to the light measurement device 102, the output module 308 configures the processor 104 to update the display device 112 to display the measured gloss value of the sample 103 under analysis.

In a further implementation, the output module 308 configures the processor 104 to send or transmit the gloss measurement for the sample 103 under analysis to one or more databases, such as a persistent storage 108. In a particular implementation, the persistent storage 108 is a data storage device, such as a hard disk or memory storage device. In an alternative arrangement, the persistent storage 108 is a remote data storage device. For example, the persistent storage 108 is a remote database, such as a cloud storage device or other remotely accessible data storage device. In one particular implementation, where the user has input the material of the sample to be evaluated, the output module 306 causes the gloss value and other data received from the user to be transmitted to the persistent storage 108. For example, a remote database is serially updated with the gloss values of different materials as they are evaluated using the light measurement device 102.

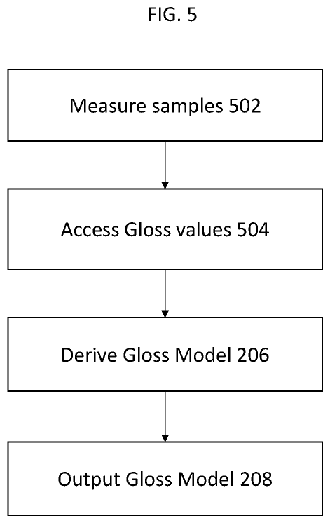

Returning to model access step 204, in one or more implementations, there is no available gloss model for a particular material type or class of material type. In such circumstances, a method of generating a gloss model can be employed to generate the necessary gloss model for use in steps 204-206. As shown in FIG. 5, a light measurement device, such as but not limited to light measurement device 102 is used to generate the gloss model as in steps 502-508. In a particular configuration, the processor 104 is configured by a model generation module 505. Here, the model generation module 505 is code operating in a processor, such as but not limited to, processor 104 or a processor of the remote computing device, to obtain a series of sample measurements of a number of samples. For example, a collection of black samples of different materials are measured according to measurement step 202, as shown in step 502. The measurement obtained in step 502 is then paired with the known gloss value for each of the samples as in step 504. The raw measurement data for the black gloss sample of a given material is stored in persistent storage 108 such that a collection of data about the raw measurement values for the different black samples is generated. This process is repeated until sufficient data points have been generated, such as, but not limited to, sufficient data samples to generate the chart of FIG. 4. For example, in a color measurement device that measures reflectances using matrix-transformation method, as disclosed in “Method to Compensate Surface Gloss in Spectrum Recovery” by Z. Xu, et. al., a signal-gloss relationship can be built by measuring a series of black gloss samples, and an arbitrary sample's gloss value can be estimated using this relationship by measuring a black sample that can represent the said arbitrary sample's surface gloss.

In one implementation, the signal-gloss relationship (e.g. the relationship between the measurement values obtained in step 502 and the gloss values that correspond to the measurement values obtained in step 504 can be fitted with a simple math function such as polynomial or exponential function, with gloss as the independent variable and raw counts as the dependent variable, or vice versa, as shown in step 206.

In another implementation, the raw counts of the measured signal can be normalized with a white calibration standard and/or a black trap, so different instrument of the same type (such as different versions of light measurement device 102) will have comparable results. By using this arrangement, the gloss model for a particular type of instrument is constructed. Such a gloss model can then be used across a fleet of the same instrument types.

In yet another implementation, the model generation module 505 configures the processor 104 to generate a gloss model from a light measurement device 102 that has multiple discrete channels, where each channel may have a different center wavelength. In this case, the model generation module 505 configures the processor 104 to calculate raw counts using a subset of the channels. In an alternative configuration, the model generation module 505 configures a processor to use the full set of the channels that are available to the light measurement device 102. For instance, the model generation module 505 configures a processor to select either the full set of channels of the light measurement device 102 or a subset thereof depending on which gives the best gloss estimation result. For example, if the samples used to build signal-gloss relationship are not totally black but with some red tint, then some of the sensor channels may receive the red-light signals from the body of the samples and those channels are less useful to build the signal-gloss relationship, but some other channels not sensitive to red light may still be good and can be used to build the signal-gloss relationship. In one particular implementation, the processor 104 is configured to use the color measurements made by the light measurement device 102 to determine whether the one or more channels should be excluded from the gloss model generation process. As provided in the foregoing example, where the measurement of a supposed black sample produces measurement that data that indicates a red tint is present in the sample color, the processor 104 is configured to remove those channels that are suspectable to error based on such an analysis.

In yet another implementation, instead of using raw counts and gloss values to build the gloss model using the model generation module 505 a processor is configured to use color values calculated from raw counts, such as Y-values (from X,Y,Z) or L* values (from L*,a*,b*) to generate the gloss model. For example, the model generation module 505 configures the processor 104 to use the gloss values and color values to build the gloss model.

Once the gloss model is derived, as in step 506, it can be output directly to the processor for further use. For example, as in step 508, the gloss model is output to a data storage device or directly to a processor for further use in evaluating samples.

The gloss estimation method disclosed here can find many applications. For example, it can be combined with the gloss compensation method disclosed in U.S. patent application Ser. No. 16/895,889 by Z. Xu and B. Binder: Compensate surface gloss in spectrum recovery. By way of non-limiting example, a method is provided to first estimate the gloss of a color sample with the gloss estimation methods provided herein. Using the derived estimated gloss value, a gloss compensation factor based on the estimated gloss is determined. For example, a suitably configured processor is configured to transform the estimated gloss value into a gloss compensation factor. The gloss compensation factor can then be used, according to the method disclosed in U.S. patent application Ser. No. 16/895,889, herein incorporated by reference as if presented in its entirety, to calculate the color of the sample. By doing this, the calculated color from different geometries can match each other much more closely.

While this specification contains many specific embodiment details, these should not be construed as limitations on the scope of any embodiment or of what can be claimed, but rather as descriptions of features that can be specific to particular embodiments of particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

Publications and references to known registered marks representing various systems are cited throughout this application, the disclosures of which are incorporated herein by reference. Citation of any above publications or documents is not intended as an admission that any of the foregoing is pertinent prior art, nor does it constitute any admission as to the contents or date of these publications or documents. All references cited herein are incorporated by reference to the same extent as if each individual publication and references were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the points that follow, the respective features recited in those points, and by equivalents of such features.

What is claimed is:

1. A method of determining the gloss properties of a sample, the method comprising the steps of:
measuring, using a light measurement device, light emitted by an illuminant and reflected off of the sample to obtain one or more raw measurement values;
accessing, using one or more processors configured to execute code, a gloss model, wherein the gloss model is configured to accept the one or more raw measurement values as input values to the gloss model and output a corresponding gloss value;
applying, using one of the one or more processors, the one or more raw measurement values as an input to the gloss model;
receiving, using one of the one or more processors, as an output from the gloss model, a gloss value that corresponds to the at least the one or more raw measurement values;
outputting, using one or more processors, the gloss value to one or more output devices.

2. The method of claim 1 further comprising the step of:
adjusting the gloss value received from the gloss model according to one or more additional adjustment functions.

3. The method of claim 2, wherein the one or more additional adjustment functions is at least one of a color calibration function or a transformation matrix.

4. The method of claim 2, wherein the derived gloss value is adjusted based on the color measurement of the sample.

5. The method of claim 2, further comprising the step of:
filtering, using one of the one or more processors, the one or more raw measurement values prior to applying the at least one or more measurement values to the gloss model.

6. The method of claim 5, wherein the one or more processors are configured to filter the one or more measurement values based on a measured color value of the sample.

7. The method of claim 1, wherein the measurement values are color values.

8. The method of claim 7, wherein the color values are tristimulus values (X,Y,Z) or L* values (L*,a*,b*).

9. The method of claim 1, wherein the sample is substantially black in color.

10. The method of claim 1 wherein the gloss model is generated by obtaining, with a control light measurement device, (1) a plurality of measurements of a plurality of calibration samples, where at least one of the plurality of samples is formed of a different surface gloss than another of the plurality of samples, and (2) a gloss value for each of the plurality of calibration samples, and deriving, using a calibration processor configured to execute code, a gloss model that represents the correlation between the plurality of measurements of a plurality of calibration samples and the gloss value for each of the plurality of calibration samples.

11. The method of claim 1 wherein the light measurement device and illuminant are in a 45/0 instrument configuration.

12. A method of generating a raw measurement gloss model, the method comprising the steps of:
measuring, using a light measurement device, light emitted by an illuminant and reflected off of one of a plurality of samples, where the one of the plurality of samples is formed of a first material to obtain a first measurement value;
associating with the first measurement value a corresponding gloss value for the first material;
measuring, using the light measurement device, light emitted by the illuminant and reflected off of at least one other sample of a plurality of samples, where the at least one other of the plurality of samples is formed of a second material different from the first material, to obtain a second measurement value;
associating with the at least one other of the plurality of samples a corresponding gloss value for the second material;
generating, using at least the first measurement value and gloss value and the second measurement value and gloss value, a gloss model configured to receive an input of a measurement value and generate a corresponding output of a gloss value.

13. The method of claim 12, wherein the generated gloss model is a mathematical function.

14. The method of claim 13, wherein the mathematical function is one of a polynomial or exponential function.

15. The method of claim 14, wherein the gloss value for a particular sample is the dependent variable and the raw measurement value is the independent variable.

16. The method of 12, wherein the measurement values are color values.

17. The method of 16, wherein the color values are tristimulus values (X,Y,Z) or L* values (L*,a*,b*).

18. The method of 17, wherein each of the plurality of samples is substantially black in color.
